(19) United States
(12) Patent Application Publication
(10) Pub. No.: US 2023/0146201 A1
(43) Pub. Date: May 11, 2023

(54) THERAPEUTIC DEVICE

(71) Applicants: Pamela Hopkins, Orlando, FL (US); Justina Hopkins, Orlando, FL (US)

(72) Inventors: Pamela Hopkins, Orlando, FL (US); Justina Hopkins, Orlando, FL (US)

(21) Appl. No.: 17/886,367

(22) Filed: Aug. 11, 2022

Related U.S. Application Data
(60) Provisional application No. 63/209,470, filed on Jun. 11, 2021.

(51) Int. Cl. A61H 23/02

(52) U.S. Cl. CPC A61H 23/02; A61H 2201/0207; A61H 2201/1685; A61H 2201/5048; A61H 2201/5071; A61H 2201/0188

(57) ABSTRACT

A therapeutic device is disclosed, including a device including a housing to releasably engage with a plurality of tool attachments, each of the plurality of tool attachments configured to treat one or more ailments. A heat element provides heat to the plurality of tool attachments and a vibrational element provides movement to the tool attachments to permit vibrational therapy. A gyroscope determines the operating arrangement of the device to ensure the proper orientation of the device for the selected treatment protocol. A timer times the treatment and may transmit an alert when the treatment is complete. A computing device is in operable communication with the device via a near-frequency communication system to receive data from one or more sensors and to permit the user to select operational settings of the device.

### CROSS-REFERENCE TO RELATED APPLICATIONS

The present application claims priority to U.S. Provisional Patent Application No. 63/209,470 filed Jun. 11, 2021, entitled “THERAPEUTIC DEVICE” which is hereby incorporated by reference in its entirety.

### TECHNICAL FIELD

The embodiments described herein relate to therapeutic devices, and more particularly to therapeutic devices which aid in the treatment of soft tissue dysfunction, scar tissue repair, easing restriction and improving biomechanical function and prevention of many ailments.

### BACKGROUND

Any manual physical therapy, massage therapy, sports therapy (i.e., physiotherapy) is the practice in which any therapist promotes, maintains, or restores physical health through various means including physical examination, diagnosis, prognosis, patient education, physical intervention, rehabilitation, the promotion of overall health. Therapy techniques vary greatly depending on the ailment being treated such as the overuse of joints, tendons, and soft tissue that are commonly linked to certain physical behaviors such as playing sports or after an injury or surgical procedure. Of these, manual therapy techniques, compression, and vibration techniques along with heat therapy are known to be highly effective.

In recent years, massage devices have become increasingly popular for providing therapy using vibrational and static pressure, both of which are tools well used in the treatment of ailments and prevention of ailments in manual therapy. While possibly effective, those other devices offer a generalized treatment and are administered by the patient themselves without any medical input or feedback to the user, for proper utilization. Further, those other devices only provide percussive therapy without integrating other treatment techniques and does not allow for an exchange between the user and the device and archived into the user account on a computing device.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a therapeutic device is disclosed, including a device including a housing to releasably engage with a plurality of tool attachments, each of the plurality of tool attachments configured to treat one or more ailments and prevention of ailments. A heat element provides heat to the plurality of tool attachments with a vibrational element to provide movement to the tool attachments to permit with vibrational and therapy. A gyroscope determines the operating arrangement of the device to ensure the proper orientation of the device for the selected treatment protocol. A timer times each portion of the treatment and may transmit an alert when the treatment or the segment of the treatment is complete. A computing device is in operable communication with the device via a near-frequency communication system to receive data from one or more sensors and to permit the user to select operational settings of the device.

The therapeutic device aids in the treatment of soft tissue dysfunction, scar tissue repair, easing restriction and improving biomechanical function. The computing device allows the user to interact with various functionalities of the device including vibrational and pressure settings, heat settings, timing settings, and treatment protocols for various ailments and prevention of ailments. Data can be collected from various user opted online sources to allow the user and the user's team to include a professional medical staff the ability to monitor progress, track performance metrics, monitor both acute and chronic pain levels, and monitor various other metrics based on the combined algorithms the therapy tool can offer a recommended therapy to enhance to opportunity of the user to achieve their future goals.

In one aspect, the one or more sensors include a pressure sensor to measure pressure imparted to the user during the treatment.

In one aspect, the pressure sensor determines if the tool attachment is at a suitable depth during treatment.

In one aspect, the therapeutic device include one or more microphones and one or more speakers.

In one aspect, the therapeutic device includes one or more pressure plates which transmit data to the computing device to permit the analysis of the user's weight distribution whereby the data is sent to the user metric to offer a customized therapy collection based on feedback from the plates.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a block diagram of the therapeutic device components, according to some embodiments;

FIG. 2 illustrates a perspective view of the therapeutic device, according to some embodiments;

FIG. 3 illustrates a perspective view of the pressure plates, according to some embodiments;

FIG. 4 illustrates a schematic of an exemplary tool attachment, according to some embodiments;

FIG. 5 illustrates a schematic of an exemplary tool attachment, according to some embodiments;

FIG. 6 illustrates a schematic of an exemplary tool attachment, according to some embodiments;

FIG. 7 illustrates a schematic of an exemplary tool attachment, according to some embodiments;

FIG. 8 illustrates a schematic of an exemplary tool attachment, according to some embodiments;

FIG. 9 illustrates a schematic of an exemplary tool attachment, according to some embodiments; and

FIG. 10 illustrates a schematic of an exemplary tool attachment, according to some embodiments.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to therapeutic device (hereinafter referred to as “device”, “the device”, or “therapeutic device”) which aids in the treatment of soft tissue dysfunction, scar tissue repair, easing restriction and improving biomechanical function. The device is in operable communication with a smart device to allow the therapist and/or patient to interact and adjust therapy settings based on multiple data sets, with various functionalities of the device including pressure settings, angle settings, vibrational settings, heat settings, timing settings, and treatment protocols for various myoskeletal ailments and prevention of ailments.

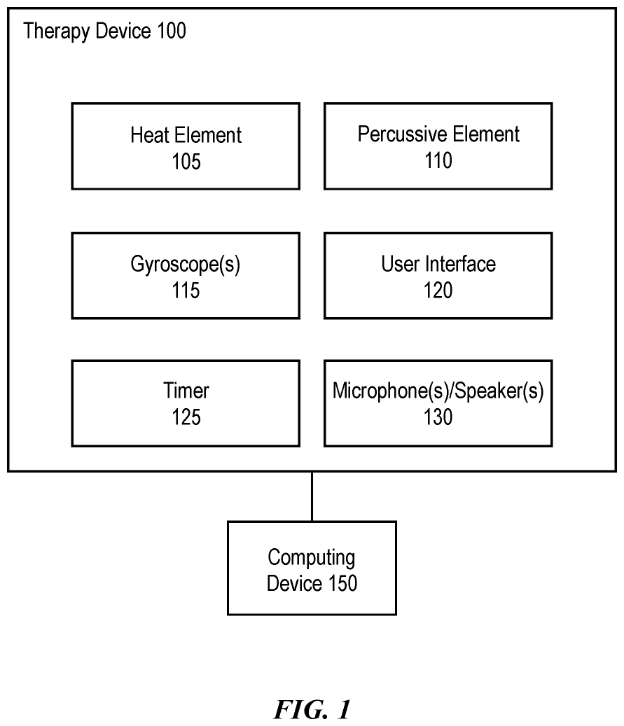

The device includes a housing which contains the electrical components described herein FIG. 1 herein. The device will follow manual therapy protocols that would make the user only attach particular tool tips that are indicative of the therapy protocol set up by the user, the history of the user whereby the recording device will recommend, or healthcare professional recommends, that when used properly, provide targeted treatment for particular ailments. For example, the user (i.e., the physician and/or the user) will follow manual therapy protocols that would be indicated to the user to use various tool tips as the program requires to move through the protocols outlined in the session programming of the tool and application of the tool. The feedback to the user will indicate slant, depth, and times stroke for the user to follow to complete the therapy session cycle.

FIG. 1 illustrates a block diagram of the therapeutic device 100 components. Each component may be in electrical communication with a power source to provide electric power to the component. A heat element 105 provides a heat source to the tool. The heat element 105 may be configured to provide heat to the entire tool attachment or to only a portion or portions of the tool attachment. A vibrational element 110 provides a vibrational force which is imparted by the tool. The vibrational element 110 may be configured to move back and forth or in various directions depending on the tool attachment or treatment protocol. One or more gyroscope(s) 115 are disposed within the device 100 to indicate an operating position of the device. The gyroscope(s) 115 ensure the user is positioning the device 100 correctly during a treatment procedure by determining the angle at which the device 100 is positioned. The device will indicate to the user if the position and depth are correct to continue through the therapy session. The device will alert the user if there is an inaccurate use, so the corrections are in real time. The device will provide an audible and physical indication for the user to adjust the position of the device 100 during treatment. A user interface 120 includes one or more buttons which allow the user to control various operational settings of the device for use either alone without a connection to a mobile device or recording device. When connected the device will update with recent information from users account or medical staff. For example, the user interface 120 may be used to adjust the heat, adjust the vibrational settings, adjust a timer 125, or activate and/or deactivate one or more microphone(s) and speaker(s). The device will have two (02) functions. The first function is a set of functions programmable by the user (similar to selecting personal preference radio settings in a car), or the use of the preprogrammed functions hard installed into the device. The second is a connected online set of downloadable customized data set for each specific user based on personal information such as height, weight, gender, physical exertions, past injuries, goals, nutrition and supplements and medications which interface with a computing device 150 (e.g., a smartphone, laptop, tablet, etc.) is in operable communication with the device 100 to allow for the remote control of the device 100 during use. The computing device 150 may allow the user to select operational settings as well as select ailments and treatment protocols. The device logs information of every session and loads it back to the computing device so the information can be shared with the healthcare professional as well as personally designed recommendations based on use and data feedback. In some embodiments, the device 100 may include one or more pressure sensors to measure pressure applied by the user during treatment. The pressure sensor may be in operable communication with the computing device 150 to display the pressure in real-time onto the display of the computing device, show as a light, a sound, and/or provide vibrational feedback. 150. The pressure sensor may aid the user in determining if a suitable tissue depth is reached during treatment.

In some embodiments, the microphone(s)/speaker(s) 130 may allow the user to voice-activate various functionalities of the device or to emit sounds which instruct the user during a treatment protocol.

In some embodiments, the device 100 may include one or more lights to indicate various metrics and operational settings. For example, the lights may indicate if the device is on or off, of a heat threshold has been reached, if a pressure threshold has been reached, if the arrangement of the device 100 is appropriate, or to indicate if a treatment protocol is complete.

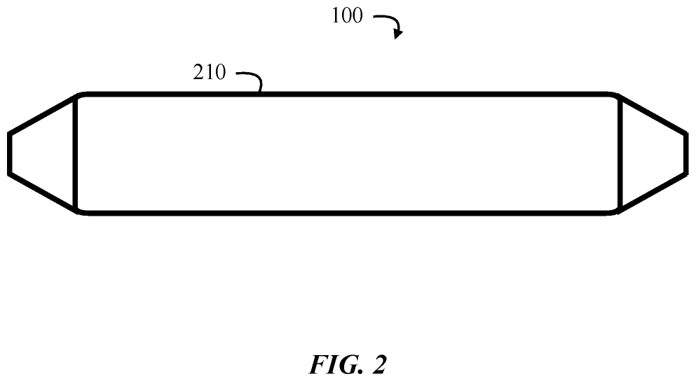

FIG. 2 illustrates a perspective view of the therapeutic device 100 including the housing 210 to contain the various components described herein. The housing 210 is configured to releasably engage each tool based on the treatment plan selected by the user. The therapeutic device may be in operable communication with a computing device via near-frequency communication systems (e.g., Bluetooth). This allows the components of the device to gather data during the treatment and transmit the data to the computing device as well as two-way data sources to adjust and change therapy and settings depending on feedback from user.

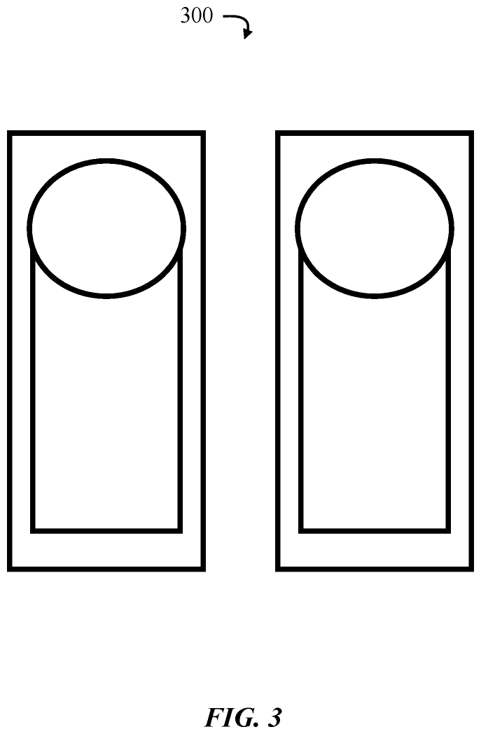

FIG. 3 illustrates the pressure plates 300 which are placed under the user's feet to analyze their weight distribution and body usage, whereby the user is walking, running or any other moving requiring the use of the foot. The pressure plates 300 may be utilized to analyze posture, or to analyze weight distribution during dynamic movements (e.g., a golf swing, baseball swing, running, and/or walking). Data received from the pressure plates may be transmitted to the computing device to allow a user to analyze the pressure points and provide insight towards determining a cause of an ailment.

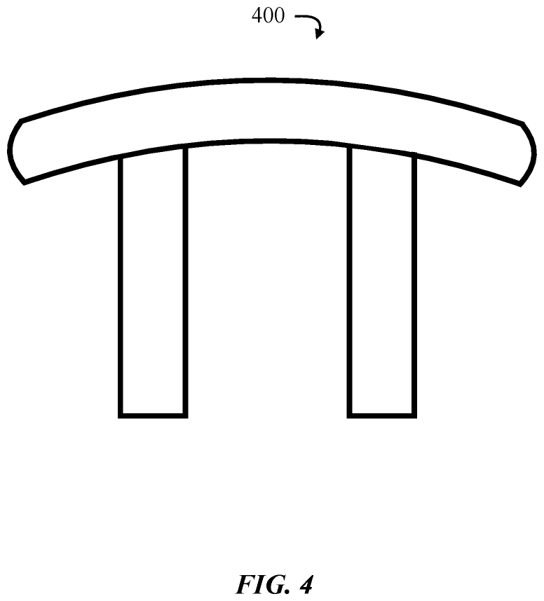

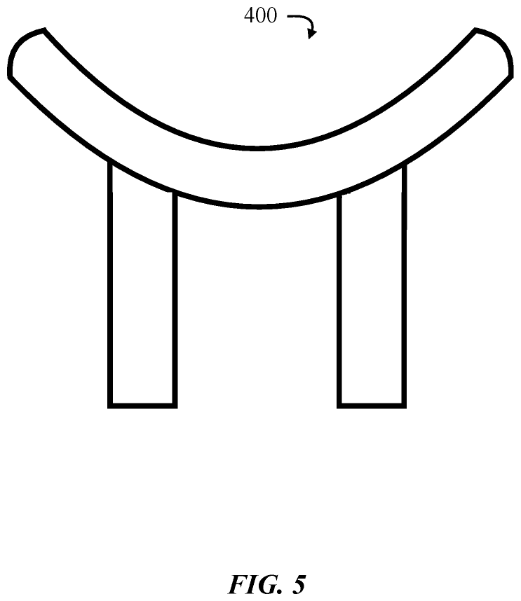

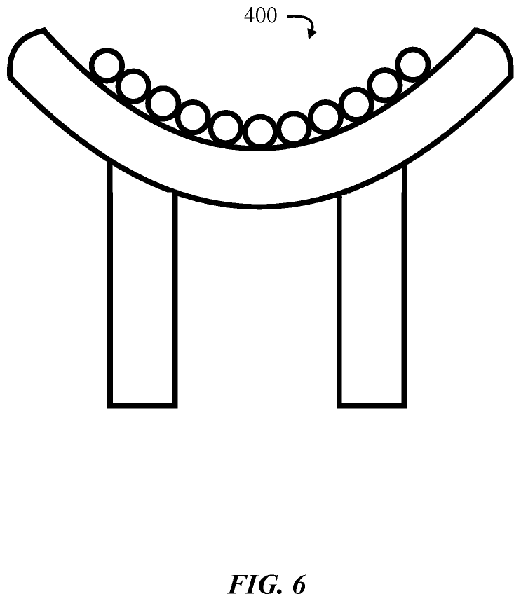

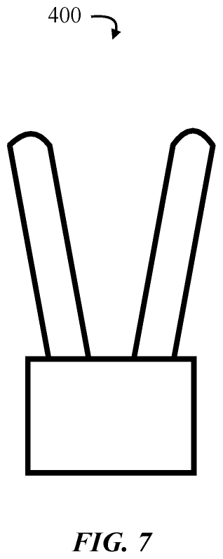

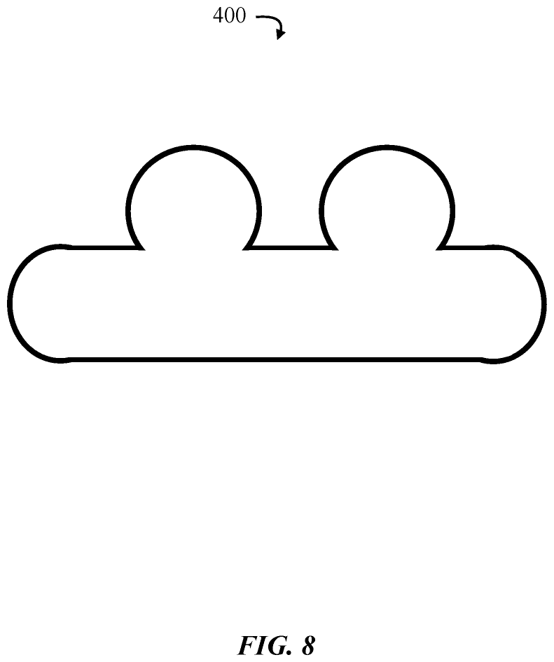

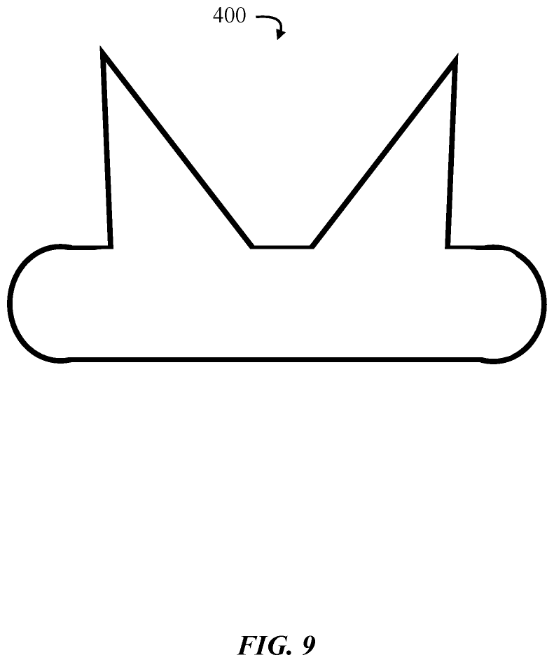

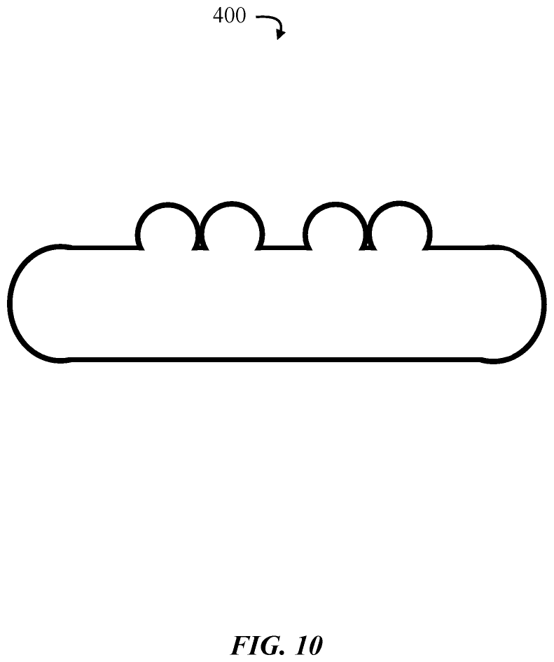

FIGS. 4-10 illustrate exemplary schematics of the tool attachments 400. Each tool attachment is configured for various treatment protocols including myofascial release of the quadriceps, shoulders, calves, lower legs, etc. The tool attachments 400 may also be configured to be positioned between the metatarsals, joints, ribs, elbows, etc. to release tissue restriction. In some embodiments, the tool attachments 400 may be used to treat the Achilles fascia, relieve scar tissue in the calcaneus and ankle, and treat hand ailments such as trigger finger and wrist restrictions. In some embodiments, the tool attachments 400 may be address tension in various parts of the body such as in the hips, treat shoulder ailments, etc. One skilled in the arts will readily understand that various tool attachments 400 may be utilized to treat various conditions.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A therapeutic device, comprising:
a device including a housing to releasably engage with a plurality of tool attachments, each of the plurality of tool attachments configured to treat one or more ailments;
a heat element to provide heat to the plurality of tool attachments;
a vibrational element to provide movement to the tool attachments to permit vibrational therapy;
a gyroscope to determine the operating arrangement of the device;
a timer to time the treatment;
a speaker to provide sound;
a computing device in operable communication with the device via a near-frequency communication system, the computing device to receive data from one or more sensors and to permit the user to select operational settings of the device.

2. The therapeutic device of claim 1, wherein the one or more sensors include a pressure sensor to measure pressure imparted to the user during the treatment.

3. The therapeutic device of claim 1, wherein the pressure sensor determines if the tool attachment is at a suitable depth during treatment.

4. The therapeutic device of claim 1, further comprising one or more microphones and one or more speakers.

5. The therapeutic device of claim 1, further comprising one or more lights, the one or more lights to indicate if we proper pressure is imparted to the user.

6. The therapeutic device of claim 5, wherein the one or more lights indicate if a proper operational angle is imparted to the user.

7. The therapeutic device of claim 1, further comprising a user interface.

8. The therapeutic device of claim 1, further comprising one or more pressure plates.

9. The therapeutic device of claim 1, wherein the one or more pressure plates transmit data to the computing device to permit the analysis of the user's weight distribution.

10. A therapeutic device, comprising:
a device including a housing to releasably engage with a plurality of tool attachments, each of the plurality of tool attachments configured to perform treatment of one or more ailments;
a heat element to provide heat to the plurality of tool attachments;
a vibrational element to provide movement to the tool attachments to permit vibrational therapy;
a gyroscope to determine the operating arrangement of the device;
a timer to time the treatment;
a speaker to provide sound;
a computing device in operable communication with the device via a near-frequency communication system, the computing device to receive data from one or more sensors and to permit the user to select one or more operational settings of the device;
a display positioned on the therapeutic device, the display in communication with the computing device to display the one or more operational settings.

11. The therapeutic device of claim 10, wherein the one or more sensors include a pressure sensor to measure pressure imparted to the user during the treatment, wherein the pressure imparted to the user is displayed on the display.

12. The therapeutic device of claim 11, wherein the pressure sensor determines if the tool attachment is at a suitable depth during treatment.

13. The therapeutic device of claim 12, further comprising one or more microphones and one or more speakers.

14. The therapeutic device of claim 13, further comprising one or more lights.

15. The therapeutic device of claim 14, further comprising a user interface.

16. The therapeutic device of claim 15, further comprising one or more pressure plates in communication with the pressure sensor.

17. The therapeutic device of claim 16, wherein the one or more pressure plates transmit data to the computing device to permit the analysis of the user's weight distribution.
